(19) United States
(12) Patent Application Publication
(10) Pub. No.: US 2011/0032245 A1
(43) Pub. Date: Feb. 10, 2011

(54) SOURCE DRIVER

(75) Inventor: Hiroyuki Inokuchi, Kyoto (JP)

Correspondence Address: CANTOR COLBURN LLP, 20 Church Street, 22nd Floor, Hartford, CT, 06103, US

(73) Assignee: ROHM CO., LTD., Kyoto (JP)

(21) Appl. No.: 12/988,186

(22) PCT Filed: Apr. 1, 2009
(86) PCT No.: PCT/JP2009/001536

§ 371 Date: Oct. 15, 2010

(30) Foreign Application Priority Data
Apr. 15, 2008 (JP) 2008-105855

(51) Int. Cl. G09G 5/00; G09G 3/36

(52) U.S. Cl. 345/212; 345/88

(57) ABSTRACT

A source driver drives data lines of a liquid crystal panel in an inversion driving manner. The source driver includes multiple charge averaging switch groups in increments of pixel colors. Each charge averaging switch connects a pairing of the nearest two corresponding data lines assigned to the same color. These two paired data lines are driven with opposite polarities. In many cases, the nearest pixels assigned to the same color have the same gradation. Thus, by performing a charge averaging operation for each of the associated data lines that correspond to such pixels, such an arrangement provides a source driver having the advantage of low power consumption.

This is a U.S. national stage application of International Application No. PCT/JP2009/001536, filed on 1 Apr. 2009. Priority under 35 U.S.C. §119(a) and 35 U.S.C. §365(b) is claimed from Japanese Application No. JP2008-105855, filed 15 Apr. 2008, the disclosure of which is also incorporated herein by reference.

### BACKGROUND OF THE INVENTION

1. Field of the Invention

The present invention relates to a driving technique for a liquid crystal panel, and particularly to a source driver configured to drive data lines in an inversion driving manner.

2. Description of the Related Art

Liquid crystal panels include multiple data lines, and multiple scanning lines arranged orthogonally to the data lines, and multiple TFTs (Thin Film Transistors) arranged in the form of a matrix, at the points of intersection of the multiple data lines and the multiple scanning lines. In order to drive the liquid crystal panel, such an arrangement includes a gate driver which sequentially selects the multiple scanning lines, and a source driver which sequentially applies voltage to each of the data lines according to a luminance.

There is a problem in that, if DC voltage is continuously applied to the data lines, such an operation leads to deterioration of the liquid crystal panel. In order to solve such a problem, in recent years, it has become mainstream for such a liquid crystal panel to employ a method in which voltages having different polarities are applied to the data lines in a AC manner (inversion driving method).

### RELATED ART DOCUMENTS

### Patent Document 1

Japanese Patent Application Laid Open No. H08-320674

With such an arrangement in which the liquid crystal panel is driven in an inversion driving manner, first, a driving voltage having a first polarity is applied to a given data line. In this stage, the parasitic capacitance that occurs at this data line is charged. Subsequently, a driving voltage having a level which is symmetrical to the first polarity with respect to a predetermined reference electric potential is applied to this data line. In this stage, the charge stored in the parasitic capacitance of the data line is discharged. The discharge current flows to the ground line as waste current. That is to say, such an arrangement in which the liquid crystal panel is driven in an inversion driving manner has a problem of increased power consumption. Furthermore, such increased power consumption leads to heat generation, which is also a problem.

### SUMMARY OF THE INVENTION

The present invention has been made in view of such a situation. Accordingly, it is an exemplary purpose of an embodiment of the present invention to provide a source driver for a liquid crystal panel which allows power consumption to be reduced.

An embodiment of the present invention relates to a source driver. The source driver is configured to drive multiple data lines of a liquid crystal panel in an inversion driving manner. The source driver comprises: multiple output terminals severally connected to the multiple respective data lines; multiple driver amplifiers severally provided to the multiple output terminals, and each configured to supply a driving voltage to the corresponding data line; multiple charge averaging switch groups provided in increments of pixel colors; and a controller configured to control the connection states of the multiple charge averaging switch groups. The multiple charge averaging switch groups each include multiple charge averaging switches arranged between the multiple data lines assigned to a corresponding pixel color.

In general, in many cases, an image to be displayed on the liquid crystal panel includes a wide region that is displayed in a single color. Accordingly, there is a high probability that pixels of the same color, and particularly the nearest pixels of the same color, have nearly identical gradations. As a result, it can be said that there is a high probability that nearest data lines assigned to the same color are driven according to nearly identical luminance data. Accordingly, in many cases, data lines connected to each other via such a charge averaging switch are driven according to nearly identical luminance data. In this case, such an arrangement provides highly uniform driving voltage due to the polarities applied to the paired data lines, thereby improving the image quality. Furthermore, such an arrangement performs the charge averaging operation, thereby reducing the waste charge.

Also, the source driver according to an embodiment may further comprise multiple output switches provided in increments of the multiple driver amplifiers, and each arranged between the corresponding driver amplifier and the corresponding output terminal. Also, the controller may be configured to control the connection states of the multiple output switches. Such an arrangement enables each driver amplifier to be disconnected from the corresponding data line in the charge averaging step in a sure manner.

Also, the multiple driver amplifiers may drive, with opposite polarities, each pair of data lines connected via a corresponding one of the multiple charge averaging switches. The term “opposite polarities” as used here means that one data line is set to a higher voltage level than a predetermined reference electric potential and the other data line is set to a lower voltage level than the reference electric potential. In this case, there is a high probability that driving voltages that are nearly symmetrical with respect the reference electric potential are applied to these two data lines, and thus, when the two data lines are connected via the charge averaging switch, the electric potentials at the two data lines are relaxed such that they approach the reference electric potential. Thus, by performing the above-described charge averaging operation before the polarities are inverted in the inversion driving operation, such an arrangement reduces the amount of charge to be supplied by the driver amplifiers or the amount of charge to be wasted. This reduces power consumption of the source driver.

Also, each of the multiple charge averaging switches may be arranged between the nearest two data lines assigned to the same color. Such an arrangement reduces resistance that is due to the wiring used to perform the charge averaging operation. This provides the source driver with reduced heat generation and high-speed operation.

Also, when multiple pixels along a given scanning line are driven, the controller may set the multiple output switches to the ON state so as to supply driving voltages to the multiple data lines. Subsequently, the controller may set the multiple output switches to the OFF state.

Subsequently, the controller may set the multiple charge averaging switch groups to the ON state for a predetermined charge averaging period of time.

Another embodiment of the present invention relates to a liquid crystal display apparatus. The liquid crystal display apparatus comprises: a liquid crystal panel; any one of the aforementioned source drivers configured to drive multiple data lines of the liquid crystal panel; and a gate driver configured to drive multiple scanning lines of the liquid crystal panel.

Such an embodiment provides reduced power consumption of the liquid crystal display.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows a configuration of a liquid crystal display including a source driver according to an embodiment;

FIG. 2 is a time chart which shows the operation of the source driver shown in FIG. 1;

FIG. 3 is a circuit diagram which shows a configuration of a liquid crystal display including a source driver according to a comparison technique;

FIG. 4 is a block diagram which shows a configuration of a driving signal generator and a controller shown in FIG. 1;

FIG. 5 is a circuit diagram which shows a configuration of a source driver according to a first modification of an arrangement of charge averaging switches; and

FIGS. 6A and 6B are circuit diagrams showing the configuration of a source driver according to a second modification of an arrangement of the charge averaging switches and the configuration of a source driver according to a third modification thereof.

### DETAILED DESCRIPTION OF THE INVENTION

Description will be made below regarding preferred embodiments according to the present invention with reference to the drawings. The same or similar components, members, and processes are denoted by the same reference numerals, and redundant description thereof will be omitted as appropriate. Also, in the drawings, the size of each component is expanded or reduced as appropriate for ease of understanding.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B. Similarly, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

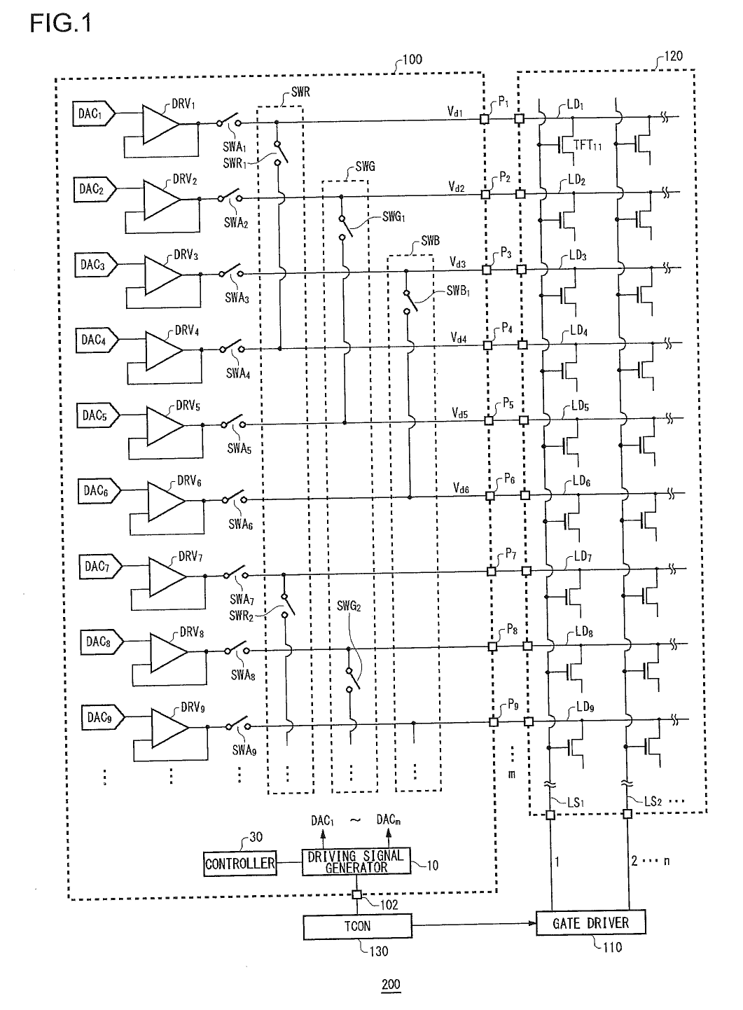

FIG. 1 is a circuit diagram which shows a configuration of a liquid crystal display 200 including a source driver 100 according to an embodiment. The liquid crystal display 200 includes a source driver 100, a gate driver 110, a liquid crystal panel 120, and a timing controller 130.

Hereafter, m and n are taken to be integers, i is taken to be an integer that satisfies the relation 1≦i≦m, and j is taken to be an integer that satisfies the relation 1≦j≦n.

The liquid crystal panel 120 includes m data lines LD and n scanning lines LS. Pixel circuits are arranged in the form of a matrix, at the points of intersection of the data lines LD and the scanning lines LS. FIG. 1 shows only TFTs arranged in increments of pixels. The gate of the TFTᵢⱼ of the i-th row and j-th column is connected to the j-th scanning line LSⱼ. The source thereof is connected to the i-th data line LDᵢ.

The data lines LD₁ through LDₘ have a structure in which multiple sets of data lines assigned to red, data lines assigned to green, and data lines assigned to blue arranged in this sequence are arranged in order. That is to say, in FIG. 1, the data lines LD₁, LD₄, LD₇, and so on are each assigned to red, the data lines LD₂, LD₅, LD₈, and so on are assigned to green, and the data lines LD₂, LD₆, LD₉, and so on are assigned to blue. In general, with k as an integer, the data line LD₃ₖ₋₂ is assigned to red, the data line LD₃ₖ₋₁ is assigned to green, and the data line LD₃ₖ is assigned to blue. It should be noted that, for simplicity of explanation, the data line LD₁₀ and the subsequent data lines are omitted.

The gate driver 110 receives data from the timing controller 130, and sequentially selects and drives the multiple scanning lines LS₁ through LSₙ.

The source driver 100 receives luminance data from the timing controller 130, and supplies driving voltage to the multiple data lines LD₁ through LDₘ according to the luminance data.

The source driver 100 includes digital/analog converters DAC₁ through DACₘ, driver amplifiers DRV₁ through DRVₘ, output switches SWA₁ through SWAₘ, a red charge averaging switch group SWR, a green charge averaging switch group SWG, a blue charge averaging switch group SWB, output terminals P₁ through Pₘ, and a data input terminal 102. The source driver 100 may be configured as a function IC monolithically integrated on a single semiconductor substrate. The output terminals P₁ through Pₘ are connected to the data lines LD₁ through LDₘ, respectively. Furthermore, the data input terminal 102 receives, as input data from the timing controller 130, luminance data in increments of pixels.

The driver amplifier DRV₂ outputs a driving voltage to the output terminal P₁ via the output switch SWA₁, which is used to drive the data line LD₁ in an inversion driving manner. The driver amplifier DRV₂ outputs a driving voltage to the output terminal P₂ via the output switch SWA₂, which is used to drive the data line LD₂ in an inversion driving manner. The same can be said of the subsequent driver amplifiers DRV₃ through DRVₘ.

The two driver amplifiers DRVᵢ and DRVᵢ₊₁, which are configured to drive the two adjacent data lines LDᵢ and LDᵢ₊₁ in an inversion driving manner, drive these two data lines LDᵢ and LDᵢ₊₁ with opposite polarities.

The red charge averaging switch group SWR includes multiple red charge averaging switches each configured to connect a pairing of the two nearest data lines assigned to red. Particularly, description will be made in the present embodiment regarding an arrangement in which the red charge averaging switch group SWR includes the red charge averaging switches SWR₁, SWR₂, and so on, respectively arranged between the data lines assigned to red, i.e., LD₁ and LD₄, and LD₇ and so on. The red charge averaging switch SWR₁ connects the data line LD₁ to the data line LD₄. The red charge averaging switch SWR₂ connects the data line LD₇ to the data line LD₁₀. In general, with l as an integer, the red charge averaging switch SWRₗ connects the data line LD₆ₗ₋₅ to the data line LD₆ₗ₋₂.

The green charge averaging switch group SWG includes multiple green charge averaging switches SWGₗ, SWGₛ, and so on, arranged in the same way as described above. In general, with l as an integer, the green charge averaging switch SWGₗ connects the data line LD₆ₗ₋₄ to the data line LD₆ₗ₋₁.

The blue charge averaging switch group SWG includes multiple blue charge averaging switches SWBₗ, SWBₛ and so on, arranged in the same way as described above. In general, with l as an integer, the blue charge averaging switch SWBₗ connects the data line LD₆ₗ₋₃ to the data line LD₆ₗ.

The controller 30 controls the connection states of the output switches SWA₁ through SWAₘ, the red charge averaging switch group SWR, the green charge averaging switch group SWG, and the blue averaging switch group SWB.

The driving signal generator 10 receives luminance data in increments of pixels via the data input terminal 102, and generates a signal to be supplied to each data line LD in the form of a digital value. The digital values thus generated in increments of data lines LD are output to the respective digital/analog converters DAC₁ through DACₘ. The digital/analog converters DAC₁ through DACₘ each convert the digital value thus received into an analog voltage, and output the analog voltages thus converted to the corresponding driver amplifiers DRV₁ through DRVₘ.

The following can be said particularly with respect to the present embodiment having the above-described configuration. With respect to the driving voltages V_{d1} through V_{d6} to be applied to the respective data lines LD₁ through LD₆, the driving voltage V_{d1} and the driving voltage V_{d4} are applied as driving voltages to be applied to the corresponding data lines assigned to red, and have mutually opposite polarities. The driving voltage V_{d2} and the driving voltage V_{d5} are applied as driving voltages to be applied to the corresponding data lines assigned to green, and have mutually opposite polarities. The driving voltage V_{d2} and the driving voltage V_{d6} are applied as driving voltages to be applied to the corresponding data lines assigned to blue, and have mutually opposite polarities.

Description will be made regarding the operation of the source driver 100 shown in FIG. 1 configured as described above. In general, in many cases, an image to be displayed on the liquid crystal panel includes a wide region that is displayed in a single color. For example, when a word processor or a spreadsheet is starting up, the image that is displayed is mostly white. Also, a computer startup login screen is nearly a single color. Accordingly, in general, pixels of the same color, and particularly the nearest pixels of the same color, have a high probability of having identical gradations. Thus, with respect to the data lines, it can be said that there is a high probability that the nearest data lines mutually assigned to the same color are driven according to identical luminance data. Based upon this consideration, with attention to the data lines LD₁ through LD₆, description will be made below regarding a situation in which the pair of data lines LD₁ and LD₄, the pair of data lines LD₂ and LD₅, and the pair of data lines LD₂ and LD₆ are each driven according to identical luminance data.

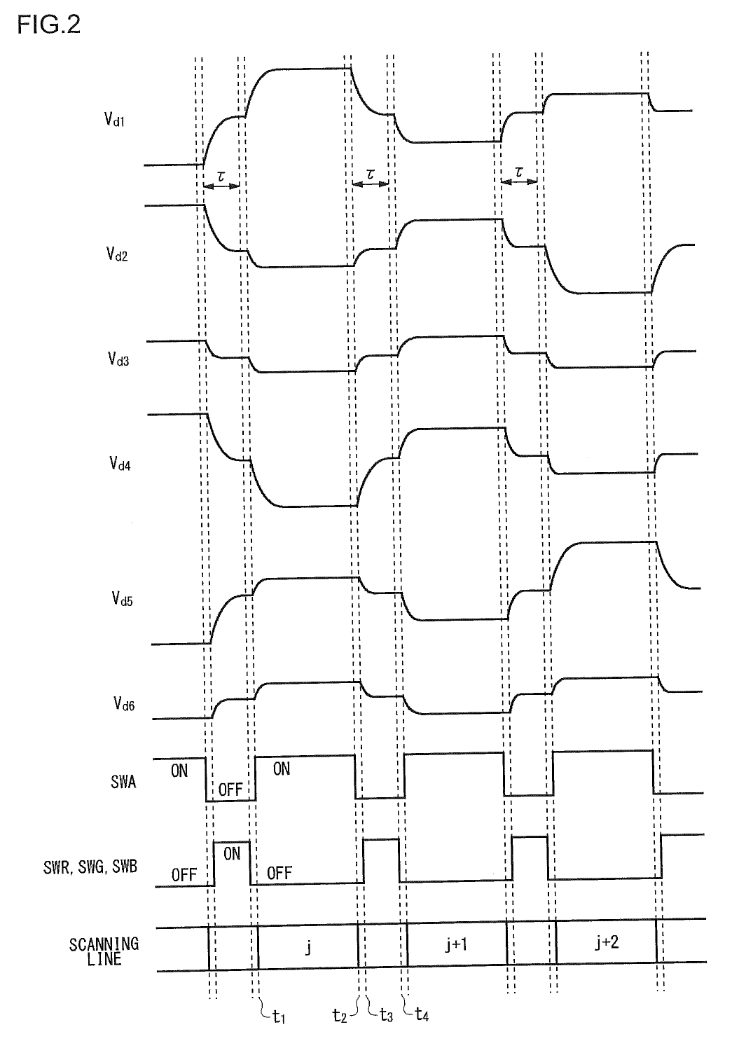

FIG. 2 is a time chart which shows the operation of the source driver 100 shown in FIG. 1. The characters “SWA” shown in FIG. 2 are a general term denoting the output switches SWA₁ through SWAₘ. The source driver 100 repeats the operation described below for every scanning line that is selected. Specific description will be made regarding a situation in which the j-th scanning line LSⱼ is selected.

At the time point t₁, the controller 30 sets the output switches SWA₁ through SWAₘ to the ON state, and the gate driver 110 selects and drives the scanning line LSⱼ. In this stage, each data line stores an amount of charge that corresponds to the driving voltage. Driving voltages having opposite polarities, which are generated according to identical luminance data, are respectively applied to the data lines LD₁ and LD₄. That is to say, driving voltages that are nearly symmetrical with respect to a reference electric potential are respectively applied to the data lines LD₁ and LD₄. The same operation is performed for the data lines LD₂ and LD₅ and the data lines LD₂ and LD₆.

At the time point t₂, after the scanning line LSⱼ has been driven for a predetermined period of time, the gate driver 110 stops the driving operation for the driving line LSⱼ, and the controller 30 sets the output switches SWA₁ through SWAₘ to the OFF state. In this state, each data line is electrically isolated.

Subsequently, at the time point t₃, the controller 30 sets the red charge averaging switch group SWR, the green charge averaging switch group SWG, and the blue charge averaging switch group SWB to the ON state. In this state, the data line LD₁ is connected to the data line LD₄, and accordingly, charge migrates from the data line LD₁ to the data line LD₄ via the red charge averaging switch SWR₁. As a result, the driving voltage V_{d1} and the driving voltage V_{d4} are relaxed such that they approach the reference electric potential. The same operation is performed for the pair of data lines LD₂ and LD₅ and the pair of data lines LD₂ and LD₆.

Subsequently, at the time point t₄ after a predetermined charge averaging period τ elapses, the controller 30 sets the red charge averaging switch group SWR, the green charge averaging switch group SWG, and the blue charge averaging switch group SWB to the OFF state. In this stage, each data line is disconnected from the other data lines. The charge averaging period τ is determined to be equal to or greater than a period of time required for the driving voltage at each data line to reach an electric potential in the vicinity of the reference electric potential. Thus, at the time point t₄, the driving voltages V_{d1} through V_{d6} are each set to an electric potential in the vicinity of the reference electric potential.

Subsequently, the next scanning line LSⱼ₊₁ is selected, and the driving voltage is supplied to each data line. In this stage, a driving voltage having a polarity that is the opposite of that of the driving voltage that was applied when the scanning line LSⱼ was selected is applied to each data line. The data lines LD₁ through LD₆ are respectively driven to predetermined driving voltages from the electric potential in the vicinity of the reference electric potential.

With the source driver 100 according to the present embodiment, data lines mutually assigned to the same color are connected to each other via the charge averaging switch. In general, there is a high probability that data lines mutually assigned to the same color are driven according to nearly identical luminance data. Consequently, in many cases, the data lines connected to each other via the charge averaging switch are driven according to nearly identical luminance data. In this case, such an arrangement provides highly uniform driving voltage due to the polarities of the paired data lines, thereby improving the image quality. Furthermore, such an arrangement performs the charge averaging operation, thereby reducing the waste charge.

The source driver 100 according to the present embodiment includes an output switch on the output side of each driver amplifier. Such an arrangement enables each driver amplifier to be disconnected from the corresponding data line in the charge averaging step in a sure manner.

With the source driver 100 according to the present embodiment, data lines to which driving voltages having opposite polarities are to be applied are connected to each other via the charge averaging switch. In general, there is a high probability that pixels displayed in the same color, and particularly the nearest pixels displayed in the same color, have identical gradations. For this reason, in many cases, the nearest two pixels connected to the data lines have nearly identical gradations. With the inversion driving method, in general, driving voltages having opposite polarities are respectively supplied to these two pixels. This means that, in many cases, driving voltages that are nearly symmetrical with respect the reference electric potential are applied to these two pixels in turn. In this case, with such an arrangement, the charge averaging operation is performed for the paired data lines to which the driving voltages having opposite polarities are applied, and thus the charge is shared by these data lines so as to assist the next application of the driving voltage. Thus, such an arrangement reduces the amount of charge to be supplied by the driver amplifiers or the amount of charge to be wasted, thereby reducing power consumption of the source driver.

With the source driver 100 according to the present embodiment, the nearest data lines mutually assigned to the same color are connected to each other via the charge averaging switch. In general, there is a high probability that data lines assigned to the same color, and particularly the nearest data lines assigned to the same color, are driven according to identical luminance data. Thus, with the present embodiment, the data lines connected to each other via the charge averaging switch are driven according to identical luminance data. In this case, such an arrangement provides highly uniform driving voltage due to the polarities of the paired data lines, thereby improving the image quality. Furthermore, such an arrangement performs the charge averaging operation, thereby reducing the waste charge.

Furthermore, as compared with an arrangement in which the charge averaging operation is performed for data lines further away from one another, such an arrangement has the advantage that the wiring resistance in the charge averaging step is low. This reduces heat generation due to the wiring resistance, and also reduces the period of time required to perform the charge averaging operation.

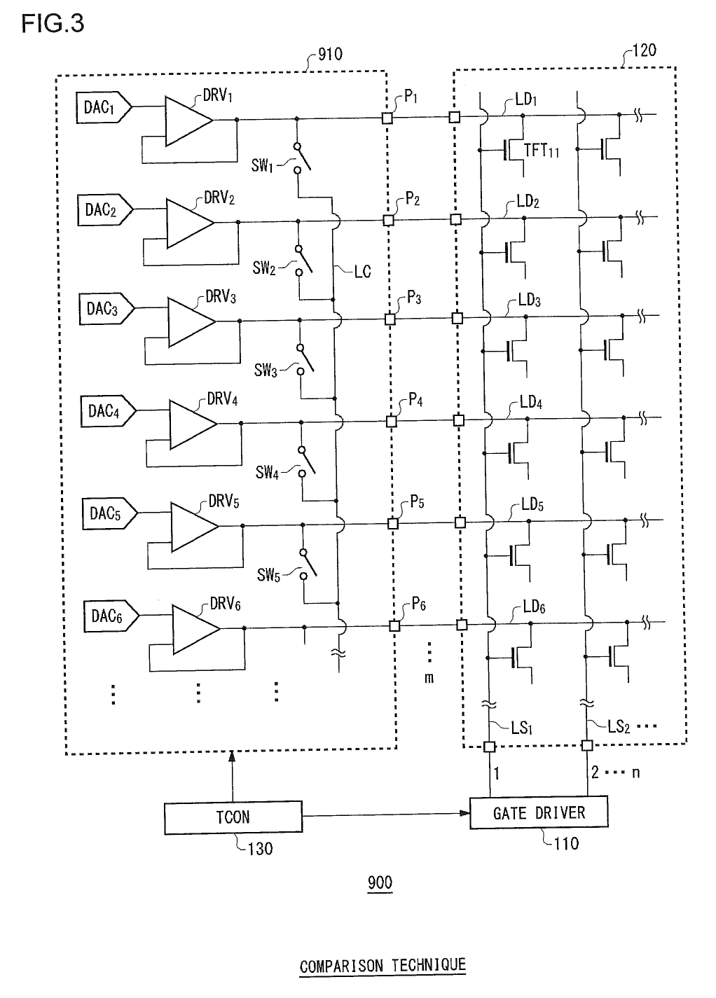

FIG. 3 is a circuit diagram which shows a liquid crystal display 900 including a source driver 910 according to a comparison technique. The liquid crystal display 900 includes a source driver 910, a liquid crystal panel 120, a gate driver 110, and a timing controller 130. The source driver 910 includes digital/analog converters DAC₁ through DACₘ, driver amplifiers DRV₁ through DRVₘ, charge sharing switches SW₁ through SWₘ, and a charge sharing line LC. The source driver 910 connects the data lines to the charge sharing line LC via the charge sharing switches SW₁ through SWₘ.

The source driver 910 includes the charge sharing switches in increments of data lines. Accordingly, the total number of the charge sharing switches is m. With such an arrangement, when charge migrates from a given data line to another data line via the charge sharing line LC, the charge passes through the two charge sharing switches.

With the source driver 100 according to the embodiment, each charge averaging switch connects a pairing of two data lines. With such an arrangement, a single charge averaging switch is provided for a pair of data lines. Accordingly, the total number of charge averaging switches is m/2. That is to say, the number of switches required to perform the charge averaging operation is half the number of charge sharing switches required for the source driver 910 according to the comparison technique described above. This allows the size of the source driver to be reduced.

Furthermore, with the source driver 910 according to the aforementioned comparison technique, when charge migrates from a given data line to another data line, the charge always passes through the two charge sharing switches. In contrast, with the present embodiment, when charge migrates, the charge passes through a single charge averaging switch. Thus, such an arrangement has the advantage of halving the resistance due to the charge averaging switches between the data lines. This reduces heat generation that occurs due to the charge averaging switches, thereby improving the operation speed of the source driver.

With the source driver 100 according to the present embodiment, the nearest two data lines mutually assigned to the same color are connected in a pairing. Furthermore, these two data lines are driven with mutually opposite polarities. The minimum value of the total number of switches required to fully connect m data lines is m/2. Thus, the configuration including the charge averaging switches according to the present embodiment provides the charge averaging operation with maximum efficiency while reducing the number of switches to the minimum value.

In many cases, the data line portion of a liquid crystal panel has a typical configuration in which multiple sets of three data lines respectively assigned to the three colors red, green, and blue are repeatedly arranged. Furthermore, in many cases, such an arrangement is designed such that adjacent data lines are operated with opposite polarities. With such a typical configuration of a liquid crystal panel, for example, such an arrangement is designed such that the nearest data lines mutually assigned to red are always driven with opposite polarities. Thus, the source driver 100 according to the present embodiment is compatible with such a typical configuration of the data line portion of a liquid crystal panel. Thus, the source driver 100 according to the present embodiment can be easily incorporated in existing liquid crystal display apparatuses.

Description will be made regarding an example of the control operation of the source driver 100 according to the aforementioned embodiment.

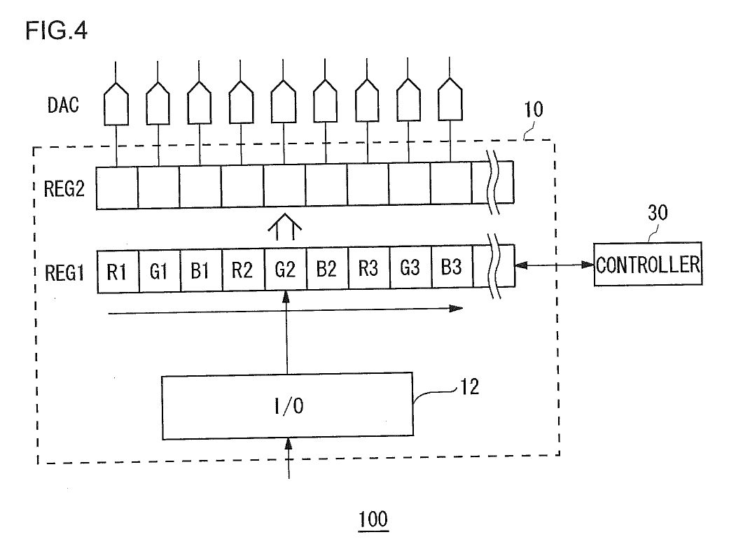

FIG. 4 is a block diagram which shows a configuration of the driving signal generator 10 and the controller 30 shown in FIG. 1. The driving signal generator 10 includes an I/O (input/output) circuit 12, a first register REG1, and a second register REG2. The second register REG2 holds the luminance data with respect to a scanning line LSⱼ which is in the driving state. The digital/analog converters DAC₁ through DACₘ perform digital/analog conversion of the luminance data held by the second register REG2, and output the luminance data thus converted to the driver amplifiers DRV₁ through DRVₘ shown in FIG. 1.

In the driving operation for the j-th scanning line LSⱼ, the I/O circuit 12 sequentially receives the luminance data for the next scanning line LSⱼ₊₁ from the timing controller 130 in synchronization with a clock signal.

The I/O circuit 12 sequentially receives the luminance data thus received in increments of data lines, and sequentially writes the luminance data thus received to the first register REG1 in the order R1, G1, B1, R2, G2, B2, and so on. After the luminance data required to scan a single scanning line are written to the first register REG1, before the driving operation for the (j+1)-th scanning line LSⱼ₊₁, the data stored in the first register REG1 are transmitted to the second register REG2 all at once. The register is configured as a desired storage apparatus such as FIFO, memory, flip-flop, latch circuit, or the like. The configuration of the register is not restricted in particular. That is to say, the driving signal generator 10 holds the luminance data for the scanning line LSⱼ₊₁ which is to be driven in the next scanning operation, as well as the luminance data for the scanning line LSⱼ which is being driven.

The controller 30 acquires the luminance data for the scanning line LSⱼ₊₁ by referring to the first register REG1. Also, the controller 30 may control the connection states of the charge averaging switches based upon a comparison between the luminance data for the scanning line LSⱼ₊₁ thus acquired and the luminance data for the scanning line LSⱼ acquired in the driving step for the scanning line LSⱼ₋₁ in the same way as in the step for acquiring the luminance data for the scanning line LSⱼ₊₁. In a case in which the gradation along the scanning line LSⱼ is opposite to the gradation along the scanning line LSⱼ₊₁, which, for example, can occur when a window edge is displayed, the driving voltages having the same polarity are applied to the pixel along the scanning line LSⱼ and the pixel along the scanning line LSⱼ₊₁ which each correspond to a given data line.

Accordingly, in this case, there is no need to perform the charge averaging operation. Thus, such an arrangement provides a flexible control operation in such a case in which the charging averaging switch is not set to the ON state.

Description has been made regarding the source driver 100 according to the embodiment. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention.

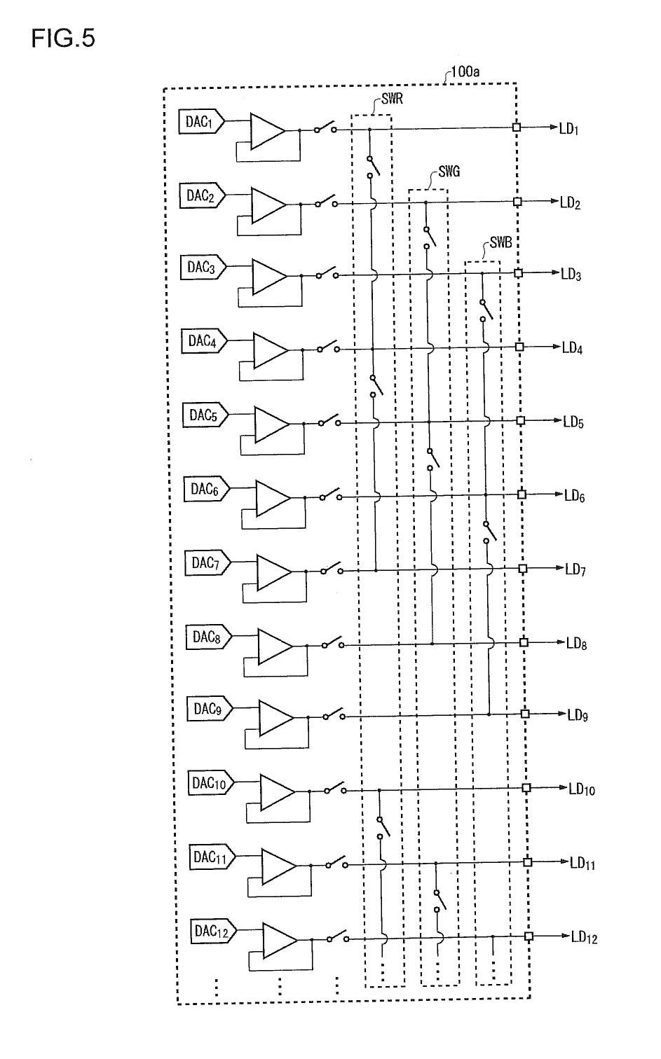

FIG. 5 is a circuit diagram which shows a configuration of a source driver 100a according to a first modification of the arrangement of the charge averaging switches. For simplicity of explanation, in FIG. 5, the data line LD₁₃ and the subsequent data lines are not shown. With the present modification, the red charge averaging switch included in the red charge averaging switch group SWR connects the data line LD₄ assigned to red to the nearest data lines LD₁ and LD₇ assigned to red. In general, with p as an integer, the red charge averaging switch included in the red charge averaging switch group SWR connects the data line LD₉ₚ₋₅ to the data lines LD₉ₚ₋₈ and LD₉ₚ₋₂.

The green charge averaging switch group SWG and the blue charge averaging switch group SWB are each arranged in the same way as the red charge averaging switch group SWR. Specifically, each charge averaging switch connects the corresponding data line and the nearest two data lines assigned to the same color as that of the aforementioned corresponding data line.

The present modification provides the same effects and the same advantages as those of the above-described embodiment in which the nearest data lines assigned to the same color are connected via the charge averaging switch.

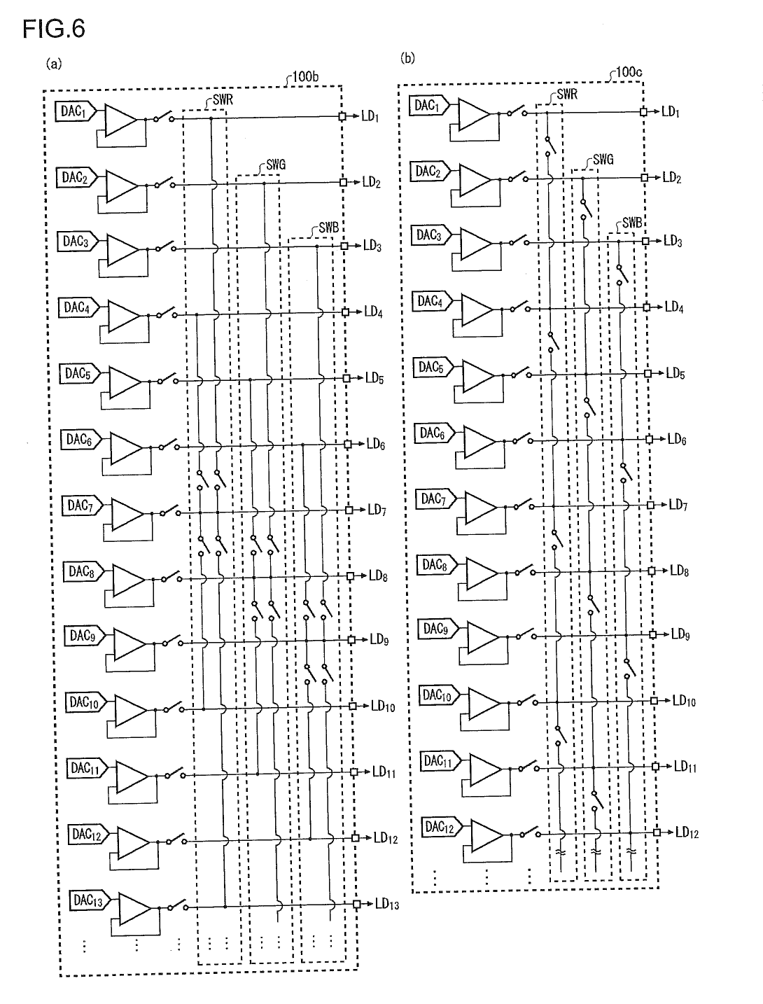

FIGS. 6A and 6B are circuit diagrams showing the configurations of a source driver 100b according to a second modification of the arrangement of the charge averaging switches and a source driver 100c according to a third modification thereof.

FIG. 6A is a circuit diagram showing the configuration of the source driver 100b according to the second modification of the arrangement of the charge averaging switches. In FIG. 6A, for simplicity of explanation, the data line LD₁₄ and the subsequent data lines are not shown. With the present modification, the red charge averaging switch included in the red charge averaging switch group SWR connects the data line LD₇ assigned to red to the surrounding data lines LD₁, LD₄, LD₁₀, and LD₁₃ assigned to red. In general, with p as an integer, a red charge averaging switch included in the red charge averaging switch group SWR connects the data line LD₁₅ₚ₋₈ to the data lines LD₁₅ₚ₋₁₄, LD₁₅ₚ₋₁₁, LD₁₅ₚ₋₅, and LD₁₅ₚ₋₂.

The green charge averaging switch group SWG and the blue charge averaging switch group SWB are each arranged in the same way as the red charge averaging switch group SWR. Specifically, each charge averaging switch connects the corresponding data line and the surrounding four data lines assigned to the same color as that of the aforementioned corresponding data line.

The present modification provides the same effects and the same advantages as those of the above-described embodiment in which the nearest data lines assigned to the same color are connected via the charge averaging switch.

FIG. 6B is a circuit diagram showing a configuration of a source driver 100c according to a third modification of the arrangement of the charge averaging switches. In FIG. 6B, for simplicity of explanation, the data line LD₁₃ and the subsequent data lines are not shown. With the present modification, the red charge averaging switch included in the red charge averaging switch group SWR connects all the data lines assigned to red. The green charge averaging switch group SWG and the blue charge averaging switch group SWB are each arranged in the same way as the red charge averaging switch group SWR. Specifically, the charge averaging switches connect all the data lines assigned to the same color.

With the present embodiment, particularly in a case in which the image that is displayed is for the most part a single color, the charge averaging operation is performed with higher efficiency, thereby reducing power consumption of the source driver.

Description has been made regarding the present invention with reference to the embodiments. However, the above-described embodiments show only the mechanisms and applications of the present invention for exemplary purposes only, and are by no means intended to be interpreted restrictively. Rather, it is needless to say that various modifications and various changes in the layout can be made without departing from the spirit and scope of the present invention defined in appended claims.

1. A source driver configured to drive multiple data lines of a liquid crystal panel in an inversion driving manner, the source driver comprising:
multiple output terminals severally connected to the multiple respective data lines;
multiple driver amplifiers severally provided to the multiple output terminals, and each configured to supply a driving voltage to the corresponding data line;
multiple charge averaging switch groups provided in increments of pixel colors; and
a controller configured to control the connection states of the multiple charge averaging switch groups,
wherein the multiple charge averaging switch groups severally include multiple charge averaging switches arranged between the multiple data lines assigned to a corresponding pixel color.

2. A source driver according to claim 1, further comprising multiple output switches provided in increments of the multiple driver amplifiers, and each arranged between the corresponding driver amplifier and the corresponding output terminal,
wherein the controller is configured to control the connection states of the multiple output switches.

3. A source driver according to claim 1, wherein the multiple driver amplifiers drive, with opposite polarities, each pair of data lines connected via a corresponding one of the multiple charge averaging switches.

4. A source driver according to claim 1, wherein each of the multiple charge averaging switches is arranged between the nearest two data lines assigned to the same color.

5. A source driver according to claim 2, wherein, when multiple pixels along a given scanning line are driven,
the controller sets the multiple output switches to the ON state so as to supply driving voltages to the multiple data lines,
following which the controller sets the multiple output switches to the OFF state,
following which the controller sets the multiple charge averaging switch groups to the ON state for a predetermined charge averaging period of time.

6. A liquid crystal display apparatus comprising:
a liquid crystal panel;
a source driver according to claim 1, configured to drive multiple data lines of the liquid crystal panel; and
a gate driver configured to drive multiple scanning lines of the liquid crystal panel.

7. A liquid crystal display apparatus comprising:
a liquid crystal panel;
a source driver according to claim 2, configured to drive multiple data lines of the liquid crystal panel; and
a gate driver configured to drive multiple scanning lines of the liquid crystal panel.

8. A liquid crystal display apparatus comprising:
a liquid crystal panel;
a source driver according to claim 3, configured to drive multiple data lines of the liquid crystal panel; and
a gate driver configured to drive multiple scanning lines of the liquid crystal panel.

9. A liquid crystal display apparatus comprising:
a liquid crystal panel;
a source driver according to claim 4, configured to drive multiple data lines of the liquid crystal panel; and
a gate driver configured to drive multiple scanning lines of the liquid crystal panel.

10. A liquid crystal display apparatus comprising:
a liquid crystal panel;
a source driver according to claim 5, configured to drive multiple data lines of the liquid crystal panel; and
a gate driver configured to drive multiple scanning lines of the liquid crystal panel.
